(19) United States
(12) Patent Application Publication
(10) Pub. No.: US 2015/0273337 A1
(43) Pub. Date: Oct. 1, 2015

(54) Authenticate user with wireless game controller

(71) Applicant: Google Inc., Mountain View, CA (US)

(72) Inventor: Matt Crowley, Los Altos, CA (US)

(73) Assignee: Google Inc., Mountain View, CA (US)

(21) Appl. No.: 14/230,256

(22) Filed: Mar. 31, 2014

(51) Int. Cl. A63F 13/73; A63F 13/22

(52) U.S. Cl. CPC A63F 13/73; A63F 13/22

(57) ABSTRACT

A game controller is disclosed that can store an indication of a user account based on an association with a host device which is authenticated with the user account. The user account data may be updated to reflect a user's progress through a game or other application. In the event the user pairs the game controller with a device to which the user is not authenticated, the game controller's stored user account may be utilized by the device to advance the user to a position in the game being played on the device that is commensurate with the user's progress on the host device.

### BACKGROUND

Game controllers are typically used with a console gaming system. More recently, advances in hardware technologies that are incorporated into mobile devices have enabled software developers to write engaging video games including some that were heretofore only present on game consoles. Users may desire to use a video game controller to interface with the user's smartphone, tablet, or other mobile device. A controller may be connected to a game console or mobile device using a wireless technology such as Bluetooth or a wired connector such as USB. Many game consoles and mobile devices are associated with a user account into which a user may login to maintain information about the content the user possesses or the user's progress in one or more video games.

### BRIEF SUMMARY

According to an implementation of the disclosed subject matter, a game controller may be connected to a host device. The host device may be authenticated to a user account. The user account may include a game profile that includes a user identifier and at least one indication of a game progress for at least one game. A request to associate the game controller with the user account of the host device may be provided. Responsive to the request, an indication of the user account may be stored to a computer readable medium of the game controller, thereby associating the user account with the game controller. The indication of the user account stored to the game controller may be updated based upon a change in the user account.

In an implementation, a system is disclosed that includes a host device. The host device may be authenticated to a user account that includes a game profile. The game profile may include a user identifier and at least one indication of a game progress for at least one game. The host device may have a first computer readable medium, a display, and a first processor. The first processor may be configured to receive a connection from a game controller and provide a request to associate the game controller with the user account of the host device. The first processor may receive a response to the request and, based on the response, provide an indication of the user's account on a second computer readable medium of the game controller thereby associating the user account with the game controller. The first processor may be configured to updating the indication of the user account stored to the game controller based upon a change in the user account. The system may include a game controller that has a second processor and a second computer readable medium. The second processor may be configured to connect to the host device and provide a response to the request indicating a desire to associate the user account with the game controller. The second processor may store the indication of the user account to the computer readable medium of the game controller. The second processor may receive the update to the indication of the user account.

In an implementation, a game controller device is disclosed that includes a computer readable medium configured to store an indication of a user account based on a response to a request. The user account may include a game profile that may have a user identifier and at least one indication of a game progress for at least one game. The device may include a communication module that is configured to connect the device with a host device. The host device may be authenticated to the user account. The device may include a processor configured to receive the request to associate the device with the user account of the host device. The processor may be configured to provide the response to the request indicating a desire to associate the user account with the device. The processor may be configured to update the indication of the user account stored to the computer readable medium of the device based upon a change in the user account.

In an implementation, a system according to the presently disclosed subject matter includes a means for receiving a connection from a game controller by a host device. The host device may be authenticated to a user account that includes a game profile. The system may include a means for providing a request to associate the game controller with the user account of the host device and receiving a response to the request. The system may include a means for storing an indication of the user account on a game controller, thereby associating the user account with the game controller. The system may have a means for updating the indication of the user account stored to the game controller based upon a change in the user account.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIGS. 3A and 3B show examples of a game controller as is known in the prior art.

FIG. 4 shows an example process for associating a game controller with a host device, storing an indication of a user account on the game controller, and updating the user account data dynamically as disclosed herein.

FIG. 5 shows an example of a system that includes a game controller and a host device in which the game controller is provided with user account data based on the user account data associated with the host device as disclosed herein.

FIG. 6 is an example process for utilizing a game controller as disclosed herein with a second host device that is not connected to the internet and that is not authenticated with the user account with which the game controller is authenticated.

### DETAILED DESCRIPTION

As disclosed, a user may authenticate a user account to access a game profile that may include a game progress, an achievement, an unlocked item, an unlocked level, a virtual character ability, and/or a game customization (e.g., a character skin) The game controller may store a user's level data for one or more video games and present it in the form of visual and/or audio feedback. In some instances, it may be cumbersome to log into a user account on a gaming system attached to a TV or otherwise. For example, a user may need to navigate a QWERTY virtual keyboard shown on the TV to login with a username and password. A wireless game controller is disclosed herein that may be personalized to one or more specific users such that each user may login into a user account with the controller. The personalized game controller may act as a user's “key” to authenticate the user into services associated with the user's account. In addition, the game controller may provide a visual and/or audio feedback to indicate a particular user and/or a particular user's progress within a game the user is playing. For example, the game controller may illuminate LEDs in a blue color if the user is at a first level and red once the user levels up in the game. The game controller disclosed herein may be utilized with a host device (e.g., a tablet or smartphone) in an offline mode. The offline usage of the authenticated game controller may allow the game operating on the host device to recognize the progress the user has made in a game based on the game progress stored to the game controller. For example, the user may attempt to connect to a host device for the first time with an authenticated game controller. The host device may ascertain the user's progress in a game by obtaining it from the game controller. The game controller may indicate that the user is at level 20 of the game. Rather than require the user to begin the game anew, at level 1, the host device and game operating thereon may allow the user to advance to level 20 and afford the user all of the progress earned therewith. If the host device is offline, the game controller may update the user account and/or game profile to reflect any advancement and/or changes to the user's game profile (e.g., a level advancement while offline, obtainment of a new item while offline, etc.) during such offline play and/or when the host device is online. Thus, the host device and/or the game may be able to determine a game progress based on the game state saved in the game controller. A video game played on a host device that is not online may advance a user's game progress and/or earned achievements without connecting to a backend server during the offline gameplay. While the implementations disclosed herein are in the context of a game controller, other devices that are similar (e.g., a remote control, a key chain or a key fob) may be personalized, authenticated, and utilized in an offline mode as disclosed herein.

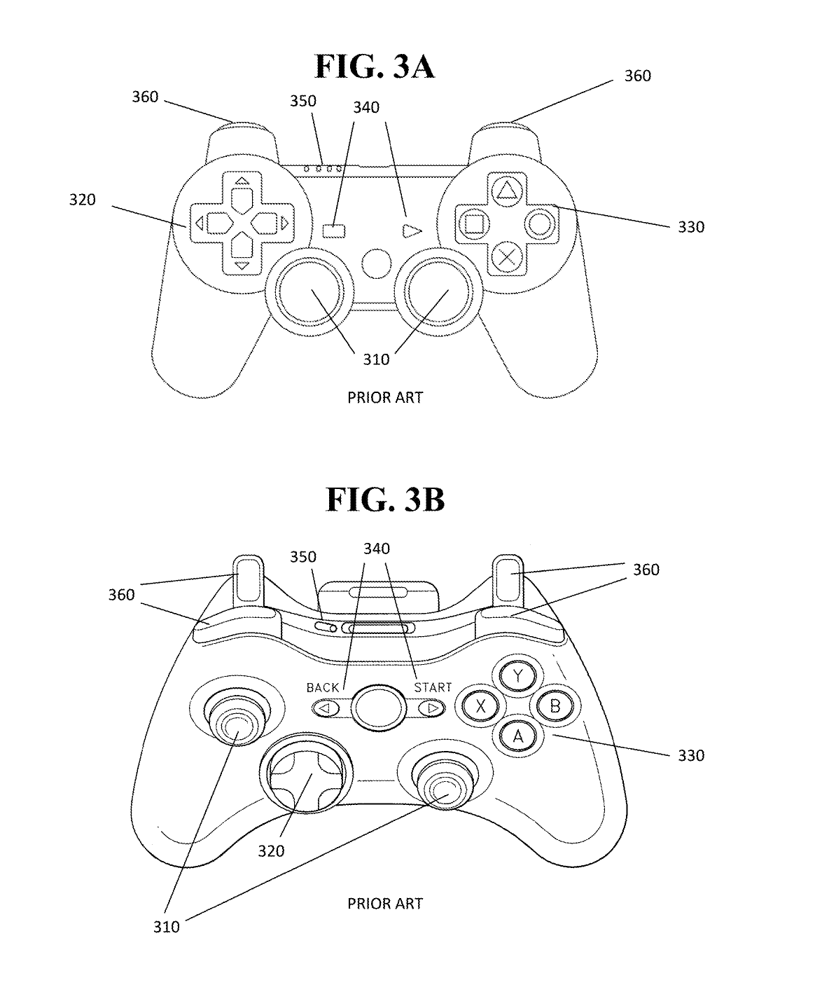

FIGS. 3A and 3B show examples of two different configurations for a game controller, each with a different configuration. A game controller may have one or more analog joysticks 310, a directional pad 320, one or more gameplay buttons 330 (e.g., the triangle, square, circle, and X buttons in FIG. 3A and/or the A, B, X, and Y buttons in FIG. 3B), a select/start button 340, a connectivity indicator 350, and one or more shoulder/trigger buttons 360 as shown in FIGS. 3A and 3B. Other configurations of the analog joysticks, directions pad, and other buttons exist in game controllers. The game controller may connect to a console or other device using a cable (e.g., USB, or other similar proprietary connector) or a wireless technology (e.g., Bluetooth).

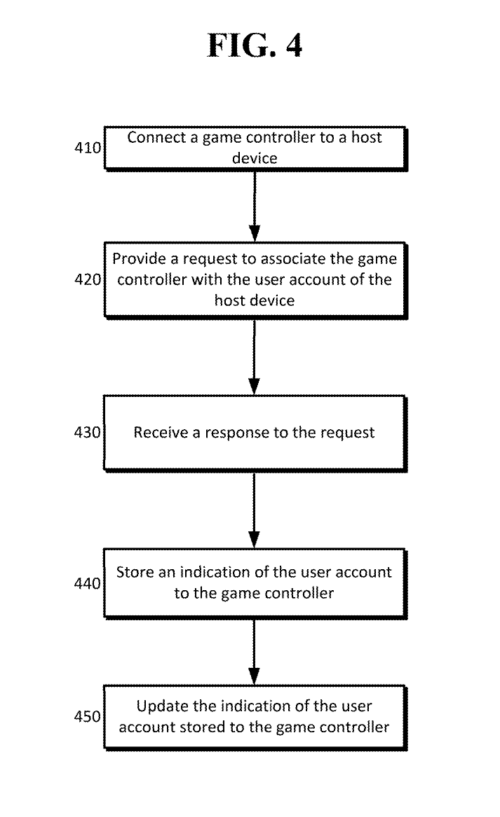

In an implementation, an example of which is provided in FIG. 4, a game controller may be connected to a host device. The host device may be, for example, a television, a tablet, a smartphone, a game console, etc. The host device may be authenticated to a user account at 410. For example, a smartphone may be associated with a particular email address or other identifier that uniquely identifies a particular user as operating that smartphone. The user account may include data about a user's preferences, a user's browsing habits and/or history, a purchase history, a download history, one or more preferred languages, one or more applications operating on one or more of the devices associated with the user account, a device access history, an email account, a game profile, etc. A device being authenticated to a user account may refer to the device's activities being associated with the particular user account and/or the device being capable of accessing data stored to the user account (e.g., email, purchased songs or movies, etc.). The game profile may include an indication of one or more games and/or a user's progress for each game. For example, a game profile may indicate that applications A, B, and C correspond to game titles, “Game A[,]” “Game B[,]” and “Game C[,]” respectively. It may indicate items a user has acquired for each game (e.g., by an identifier, name, or otherwise), a user's level (or virtual character's level) for each game, one or more tasks that the user has completed or has yet to complete, a position of a user (or virtual character) within the game (e.g., location on a map, a level or map that the user is on, etc.), one or more achievements for each game, one or more abilities for each game, and/or one or more purchased items (e.g., power-ups, items purchased with actual, virtual, and/or in-game currency, etc.).

A request may be provided, by the host device for example, to associate the game controller with the host device at 420. Connection of the game controller to the host device may permit a user to manipulate or navigate a user interface and interact with content on the host device (e.g., a video game, a movie, etc.). The game controller may operate in a “guest” mode in such situations where it is not associated with a specific user account and/or an access code for a specific user account has not been entered into the game controller (as described below). At step 420, the host device may show a window on its display that asks a user whether or not the user would like to store, authenticate, and/or associate the user account (e.g., the user account with which the host device is associated) with the game controller. The prompt may be an example of a request to associate the game controller with a user's account.

A guest mode may permit all of the functionality of any buttons, joysticks, or directional pad of the game controller. The controller operating in a guest mode may be capable of navigating a user interface or playing any compatible game. It may not, however, store user account data and/or provide user account data (or an indication thereof) that is stored on computer readable memory to a host device (whether or not the host device has access to the Internet). In a guest mode, the controller may not authenticate a specific user or user account to another device. The guest mode may not display visual or audio feedback based on a specific user's level (e.g., that is associated with the user account specific to that user).

When the game controller is initially connected to the host device or otherwise paired with the host device, the game controller may send an identifier to the host device. The identifier may inform the host device as to the type of controller, the manufacturer of the controller, the capability of the controller (e.g., which types of buttons/joysticks, etc. that the controller has and/or whether or not the controller has the ability to store data), etc. The game controller may be associated with the user account as disclosed herein and may be disassociated from a user account at a user's request. Thus, the identifier may permit the host device to determine that a particular game controller has the ability to store, for example, user account information or the like. The host device, however, may not store such information or data until receiving a response from the user instructing it to do so (see, for example, FIG. 4).

A response to the request may be received at 430. The response may indicate that the game controller may be associated with the user account. The host device may receive a response to the request based on a user's input as to whether to allow the game controller to store an indication of the user account. Based on the response or responsive to the request, an indication of the user's account may be stored on a computer readable medium of the game controller, thereby associating the user account with the game controller at 440. A user may acquiesce to linking the controller with the host device, thereby permitting the host device to store user account data or an indication thereof on the game controller. Subsequently, if the user accesses the user account from a personal computer to determine which devices are associated with the user account, the game controller will be displayed as being associated with the user account subsequent to the user account being stored on the game controller. In some configurations, more than one user account may be associated with a game controller. Each user account may be associated with a specific access code. A user may opt not to authenticate the game controller, in which case, the device may maintain a guest mode level of operation. If, however, the user elects to authenticate the game controller with the user account of the host device, for example, the host device may prompt the user for an access code associated with the user account and/or an access code to unlock or access the user account on the game controller. The access code of the user account may be different from the access code of the user account stored or associated with the game controller. For example, an access code for the user account on the game controller may be protected by a sequence that utilizes a combination of shoulder/trigger buttons, an analog joystick movement, and a directional pad movement. Such a combination is not ordinarily possible on most non-gaming electronic devices as most interfacing with such devices is performed through a keyboard and/or mouse. The access code for the user account on the game controller may be established at the time the user account is first stored to the game controller. The access code may be an alphanumeric sequence, a pattern based on movement of a directional pad, an analog joystick, a shoulder/trigger button, a gameplay button, etc. The access code may be input based on a biometric pattern (e.g., a fingerprint) and/or a MAC address. In some configurations, the game controller may possess a radio frequency identification (“RFID”) or near-field communication (“NFC”) chipset which can communicate with a host device that is authenticated with the user account. The game controller, by virtue of its proximity and/or communication with the host device may provide, to the host device, access to the data contained in the user account stored to the game controller. For example, a user may attempt to play a game on a tablet (e.g., a host device) with a game controller that contains game profile data for several users. The host device may be authenticated with the user's account. The user may touch the game controller to the host device (e.g., bring the game controller in proximity to the host device) and thereby authenticate the specific user account stored on the game controller based on the user account associated with the host device.

The access code entered using the game controller's buttons, directional pad, and/or analog joystick may be compared by the processor of the game controller to that associated with the user account stored on the game controller. In some configurations, the host device may request entry of the access code into the controller and receive an access attempt. For example, a tablet (e.g., the host device) may display a window instructing the user to enter the access code. The access attempt may be received by the host device. The host device may compare the access attempt to a code associated with the user account for the game controller. If it determines the access attempt is incorrect, then it may activate a guest mode for the controller as described earlier.

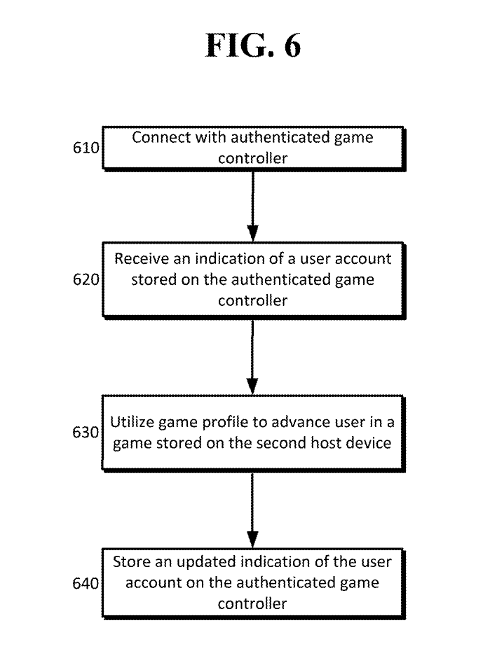

The indication of the user account stored to the game controller may be updated based upon a change in the user account at 450. Authentication of the game controller may permit the host device, or an application operating thereon, to access and/or update the user account information on the game controller. For example, a user may play a game using the authenticated game controller. The user's progress through the game may be saved to the game controller and/or to a backend server. If the user attempts to play the same game on a second device that is not associated with the user account, the second device may display a prompt that instructs a user to enter an access code or default to a guest mode if the user enters an incorrect code or does not wish to enter an access code. If, however, the user enters an access code, the game on the second device may access the user account on the game controller and advance the user's progress in the game to the same point as that indicated by the user account stored on the game controller. As described above and shown in the example provided in FIG. 6, the authenticated game controller may be connected to a second host device at 610. Authenticated may refer to a game controller that has at least one indication of a user account stored on it. The second host device may not be connected to the Internet (e.g., is not online) and it may not be associated with the user account that is stored on the game controller. The second host device may not be authenticated with the one or more user accounts with which the game controller is authenticated. The second host device may have the same application or a copy thereof (e.g., a video game) as the first host device (i.e., which is associated with the user account on the game controller). The game controller may provide an indication of the user account (e.g., game progress or the like) to the application on the second host device. The second host device may receive an indication of the user account from the authenticated game controller at 620. The user's progress in the application may be advanced to a substantially similar point of the application operating on the first host device at 630. For example, a user may play Game A on the first host device (e.g., a smartphone). The first host device may be associated with the user's account and the game controller. The game controller may be updated with the user's progress in Game A on the second host device at 640. The user may borrow a friend's second host device (e.g., a tablet) for a plane flight. The second host device may have a copy of Game A. During the flight, the tablet does not have access to the Internet. The user may connect the controller to the second host device (e.g., a tablet) and, because the controller has an indication of the user's progress in Game A stored, the second host device may advance the user's progress in Game A to a similar position to that indicated by the last state saved to the controller for Game A (e.g., from the last time the user played Game A on the first host device, the smartphone in this example). The user may not be advanced or afforded all of the items, achievements, character progress, etc. that was present for the user in the first host device's (e.g., the smartphone's) Game A application. The user may be advanced to a similar position or point in the storyline or progress of the game. For example, the user may be advanced to level 15 instead of level 16 if the advancement to level 16 in the smartphone's Game A was a very recent achievement and did not have sufficient time to be updated to the controller. As the user progresses on Game A on the second host device, the indication of the user account may be updated as shown at 640. If, subsequently, the user connects to the first host device, the updated indication of the user account may be utilized to refresh or update the user account to reflect any progress made while the user was disconnected from the first host device. That is, the progress made while playing Game A on the second host device may be saved to the controller and be utilized to update the user's progress on Game A in the first host device and/or the user's account stored on a remote server.

The game profile of the user account may be updated dynamically or periodically as achievements are obtained or unlocked, advancements in story line or character ability are made, items are acquired, etc. In some configurations, a game may have a unique level or achievement that unlocks a certain type of play ability that the player can utilize. The application may update the user account with game progress (e.g., the special play ability). It may send the update to a server which contains the user account and/or the game controller if the application is granted such authority by the user.

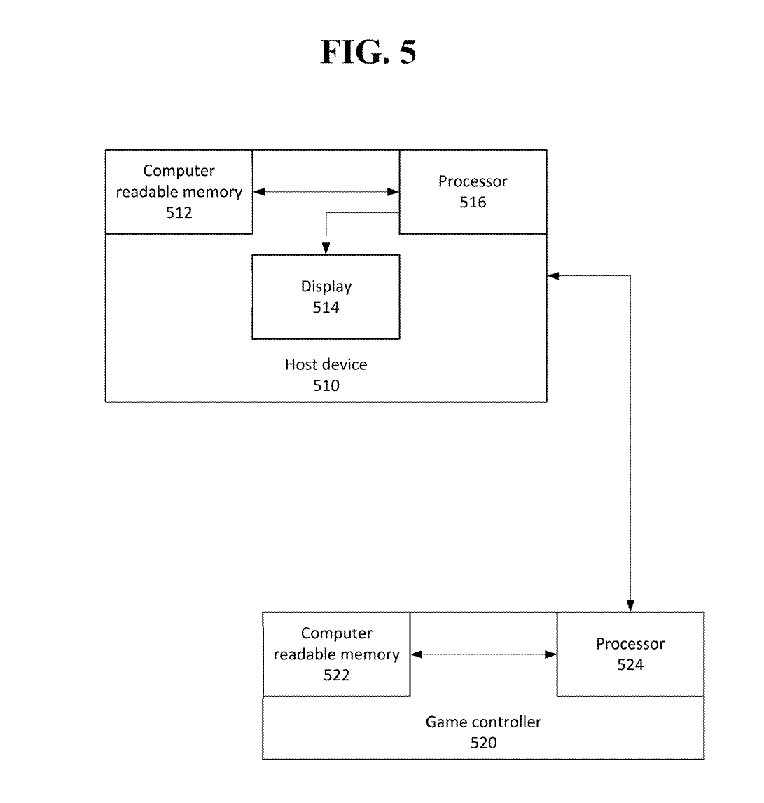

In an implementation, an example of which is provided in FIG. 5, a system is disclosed that includes a host device 510 and a game controller 520. The host device may be authenticated to a user account that includes a game profile. The game profile, as described above, may include a user identifier and at least one indication of a game progress for at least one game. The host device may have computer readable memory 512, a display 514, and a processor 516. The host device 510 may have other hardware components such as a mechanism for communicating with other devices and/or the Internet (e.g., a wireless access chipset, a NFC chipset, a Bluetooth chipset, etc.). It may contain one or more sensors that can measure touch input into the display 514 or provide movement data. The processor 516 may drive the display 514 directly or indirectly such as by a graphics chipset. The processor 516 may request data from the computer readable memory 512 and/or store information therein. The processor 516 may receive a connection from the game controller 520. For example, the game controller 520 may associate with the host device 510 by a Bluetooth connection. At this stage, no data regarding a user account is stored on the game controller 520. That is, the controller 520 is capable of interacting or being used with the host device 510 in a guest mode of operation as described earlier. The processor 516 may provide a request to associate the game controller 520 with the user account of the host device 510. For example, the request from the host device 510 may be a signal sent to the game controller 520 which may be visually indicated to the user (e.g., flashing the connectivity indicator on the controller) or otherwise indicated (e.g., with sound, vibration, etc.). As another example, the request host device 510 may display a prompt on its display 514. The user may input a response to the request. For example, the user may press a key on the controller 520 indicating an affirmative response (e.g., approving the association of the controller with the host device's user account) or another button indicating a negative response. The response may be input from the game controller 520 and received by the host device 510. Based on the response, the processor 516 of the host device 510 may provide an indication of the user's account on the computer readable medium 522 of the game controller 520, thereby associating the user account with the game controller 520. The indication of the user account may be received by the processor 524, directly or indirectly, which may direct storage of the user account data to the computer readable medium 522 of the game controller 520. The game controller 520 is now capable of being authenticating the particular user whose account is stored thereon to another device (e.g., the host device 510 or a second, offline, host device).

In subsequent uses of the game controller 520, either with the host device 510 that is authenticated with a user account or a second host device that is not authenticated with the user account, the game controller's user account data may be updated to reflect a user's progress in a game. Similarly, the progress stored on the game controller 520 may provide a starting point for a game for a user on a second host device that does not recognize the user to whom the controller 520 is authenticated. The user's progress in a particular game may be indicated by a visual or audio indicator on the controller 520 as described above.

In an implementation, a game controller device is disclosed that includes a computer readable medium configured to store an indication of a user account based on a response to a request. The user account may include a game profile that may have a user identifier and at least one indication of a game progress for at least one game. The device may include a communication module that is configured to connect the device with a host device. The host device may be authenticated to the user account. The device may include a processor configured to receive the request to associate the device with the user account of the host device. The processor may be configured to provide the response to the request indicating a desire to associate the user account with the device. The processor may be configured to update the indication of the user account stored to the computer readable medium of the device based upon a change in the user account.

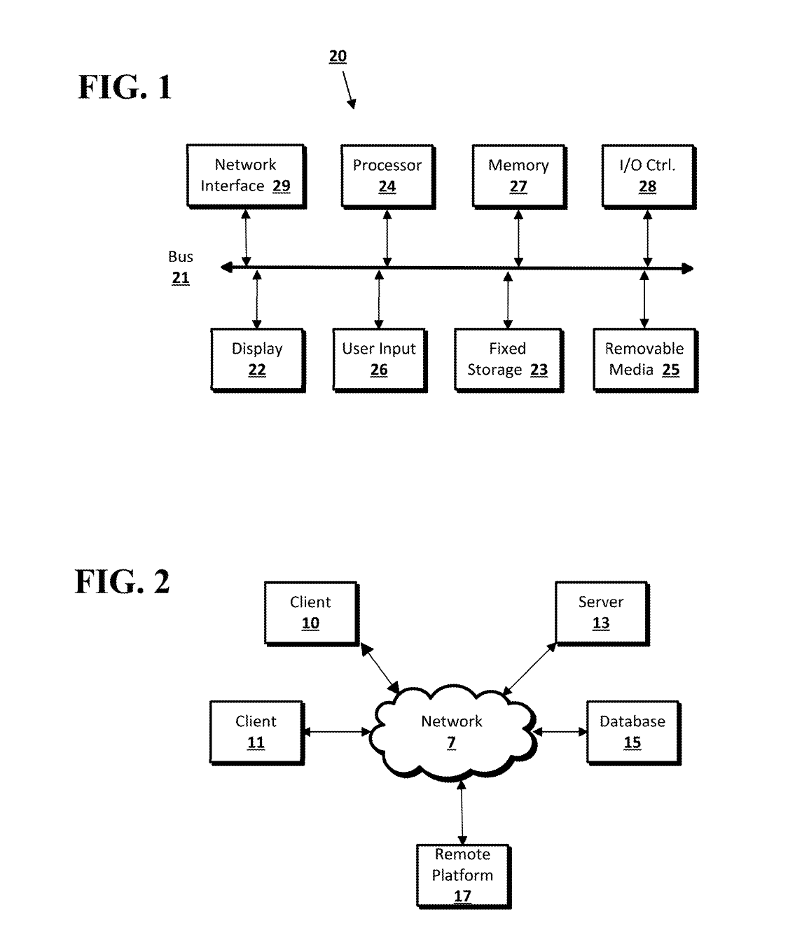

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the implementations of the disclosed subject matter collect personal information about users, or may make use of personal information, the users may be provided with an opportunity to control whether programs or features collect user information (e.g., a user's performance score, a user's work product, a user's provided input, a user's geographic location, and any other similar data associated with a user), or to control whether and/or how to receive instructional course content from the instructional course provider that may be more relevant to the user. In addition, certain data may be treated in one or more ways before it is stored or used, so that personally identifiable information is removed. For example, a user's identity may be treated so that no personally identifiable information can be determined for the user, or a user's geographic location associated with an instructional course may be generalized where location information is obtained (such as to a city, ZIP code, or state level), so that a particular location of a user cannot be determined. Thus, the user may have control over how information is collected about the user and used by an instructional course provider.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method, comprising:
connecting a game controller to a host device, wherein the host device is authenticated to a user account, wherein the user account comprises a game profile, and wherein the game profile comprises a user identifier and at least one indication of a game progress for at least one game;
providing a request to associate the game controller with the user account of the host device;
receiving a response to the request, wherein the response indicates that the game controller may be associated with the user account of the host device;
storing an indication of the user account on a computer readable medium of the game controller thereby associating the user account with the game controller; and
updating the indication of the user account stored to the game controller based upon a change in the user account.

2. The method of claim 1, wherein the indication of game progress comprises achievement data.

3. The method of claim 1, further comprising securing the user account stored on the game controller with an access code.

4. The method of claim 3, further comprising:
requesting entry of the access code into the controller; and
receiving an access attempt.

5. The method of claim 4, further comprising:
determining the access attempt is incorrect; and
activating a guest mode for the controller.

6. The method of claim 1, further comprising:
connecting the game controller to a second host device, wherein the second host device is not online and is not associated with the user account, and wherein the host device and the second host device each have a copy of an application; and
providing an indication of the user account to the application on the second host device, thereby advancing the user's progress in the application to a substantially similar point as the application on the host device.

7. The method of claim 1, further comprising providing feedback on the game controller to the user to indicate the game progress.

8. The method of claim 1, wherein a plurality of user accounts are associated with the controller, wherein each of the plurality of user accounts is associated with one of a plurality of access codes.

9. A system, comprising:
a host device, wherein the host device is authenticated to a user account, wherein the user account comprises a game profile, wherein the game profile comprises a user identifier and at least one indication of a game progress for at least one game, and wherein the host device comprises a first computer readable medium, a display, and a first processor, the first processor configured to:
receive a connection from a game controller;
provide a request to associate the game controller with the user account of the host device;
receive a response to the request;
based on the response, provide an indication of the user's account on a second computer readable medium of the game controller thereby associating the user account with the game controller; and
update the indication of the user account stored to the game controller based upon a change in the user account; and
the game controller, comprising a second processor and a second computer readable medium, the second processor configured to:
connect to the host device;
provide a response to the request indicating a desire to associate the user account with the game controller;
store the indication of the user account to the second computer readable medium of the game controller; and
receive the update to the indication of the user account.

10. The system of claim 9, wherein the indication of game progress comprises achievement data.

11. The system of claim 9, the second processor further configured to secure the user account stored on the game controller with an access code.

12. The system of claim 11, the second processor further configured to:
request entry of the access code into the controller; and
receive an access attempt.

13. The system of claim 12, the second processor further configured to:
determine the access attempt is incorrect; and
activate a guest mode for the controller.

14. The system of claim 9, the second processor further configured to:
connect the game controller to a second host device, wherein the second host device is not online and is not associated with the user account, and wherein the host device and the second host device each have a copy of an application; and
provide an indication of the user account to the application on the second host device, thereby advancing the user's progress in the application to a substantially similar point as the application on the host device.

15. The system of claim 9, the second processor further configured to provide feedback on the game controller to the user to indicate the game progress.

16. The system of claim 9, wherein a plurality of user accounts are associated with the controller, wherein each of the plurality of user accounts is associated with one of a plurality of access codes.
